(19) United States
(12) Patent Application Publication
(10) Pub. No.: US 2017/0104432 A1
(43) Pub. Date: Apr. 13, 2017

(54) CONTROL PROCESS FOR IDENTIFYING THE INDUCTANCE VALUES OF A VARIABLE-RELUCTANCE SYNCHRONOUS ELECTRIC MOTOR

(71) Applicant: Schneider Toshiba Inverter Europe SAS, Pacy sur Eure (FR)

(72) Inventors: Al Kassem JEBAI, Vernon (FR); Francois MALRAIT, Jouy sur Eure (FR); Thomas DEVOS, Carrieres sous Poissy (FR)

(73) Assignee: Schneider Toshiba Inverter Europe SAS, Pacy sur Eure (FR)

(21) Appl. No.: 15/275,927

(22) Filed: Sep. 26, 2016

(30) Foreign Application Priority Data
Oct. 13, 2015 (FR) 15 59704

(51) Int. Cl. H02P 23/00; H02P 6/08

(52) U.S. Cl. CPC H02P 23/0077; H02P 6/08

(57) ABSTRACT

A process for controlling a variable-reluctance synchronous electric motor is implemented in a processing unit coupled to a power converter connected to the electric motor. The process includes a phase of identifying a flux inductance value of the electric motor, which includes a step of generation of a reference current (ī_{d}) at the input, for each reference-current value (ī_{d}), a step of determination of a current value (ī_{d}) in the output phases, for each reference-current value (ī_{d}), a step of determination, by an identification module, of an inductance value (ī_{d}^{EST}) as a function of a reference-current value applied at the input, of the corresponding current value measured in the output phases, and of a predetermined or variable inductance value (\hat{L}_{d}).

### TECHNICAL FIELD OF THE INVENTION

The present invention relates to a control process which is implemented in a processing unit coupled to a voltage converter employed to control a synchronous electric motor. This control process aims, in particular, to determine the inductance values of said electric motor.

The invention is applicable to a variable-reluctance synchronous electric motor.

### STATE OF THE ART

An electric motor is controlled in speed by a variable-speed drive. The variable-speed drive includes input phases, in order to connect to an electricity supply network, and output phases, in order to connect to the electric motor. Said variable-speed drive conventionally includes a rectifier stage, in order to rectify the voltage of the network that is applied to the input, and an inverter stage, in order to generate variable voltages in the output phases destined for the electric motor.

Because of the magnetic saturation, the inductance values of a variable-reluctance synchronous motor vary as a function of the current injected into the stator, called the stator current.

Most of the time, however, the inductance values of the motor are chosen to be constant, giving rise to a limit in the performance of the monitoring of the motor employed.

Even so, methods exist for determining the inductance values of the motor. Patent application EP 1 641 114 A1 proposes such a method employing a position sensor positioned in the motor.

Patent application EP 2 453 248 A1 proposes another method for identifying the inductances of the motor. This method is based on the injection of voltage pulses into the motor at standstill. The flux at the stator is obtained by integrating the difference between the total voltage at the terminals of the stator and the voltage in the region of the resistance of the motor. Each inductance value of the motor is obtained by differentiating the flux with respect to the current. This method presents several drawbacks, notably of necessitating perfect knowledge of the resistance of the motor, and of obtaining precise measurements of the voltage applied to the motor.

Patent applications U.S. 2007/241715 A1, WO 2012/000507 A1 and U.S. 2013/173193 A1 describe other solutions for determining inductance values as a function of various current values.

The object of the invention is to propose a control process which is implemented in order to determine the inductance values of a variable-reluctance synchronous motor, said process being simple and reliable and necessitating neither the use of a position sensor nor the precise knowledge of the resistance of the motor or of the voltage applied to the motor.

### DISCLOSURE OF THE INVENTION

This object is achieved by a process for controlling a variable-reluctance synchronous electric motor, implemented in a processing unit, said processing unit being coupled to a power converter connected by output phases to said electric motor and designed to execute a control scheme with a view to applying variable voltages to said electric motor, the process including a phase of identifying a flux inductance value of said electric motor, this identification phase comprising:
a step of generation of a reference current at the beginning of said control scheme, said reference current taking successively several values according to a predetermined profile,
for each reference-current value, a step of determination of a current value corresponding to currents measured in the output phases of the motor,
for each reference-current value, a step of determination, by an identification module, of an inductance value as a function of a reference-current value applied at the input, of the corresponding current value determined on the basis of the currents measured in the output phases, and of a predetermined or variable inductance value,
for each current value determined on the basis of the currents measured in the three output phases, storage of the corresponding inductance value determined in the course of the determination step.

According to a distinctive feature, the reference current follows a variable profile running from a minimal or maximal defined initial value as far as a respectively maximal or minimal final value.

According to a first embodiment, the reference current takes several successive values by following a linear profile.

According to a second embodiment, the reference current takes several successive values by following a staircase profile having several rungs, each value of the reference current according to a rung of said profile.

According to another distinctive feature, the process includes an operating phase which follows the identification phase, said operating phase consisting in utilising each inductance value stored in the course of the identification phase, in order to determine a reference flux to be applied to the motor.

The invention also concerns a system for controlling a variable-reluctance synchronous electric motor, including a processing unit, said processing unit being coupled to a power converter connected by output phases to said electric motor and designed to apply variable voltages to said electric motor by executing a control scheme, characterized in that the control scheme comprises:
a module for generation of a path of a reference current,
a module for determination, for each value of the reference current, of a current value determined on the basis of currents measured in the output phases,
a module for identification of each inductance value of the electric motor on the basis of a reference-current value, the corresponding current value determined on the basis of the currents measured in the output phases, and a predetermined or variable inductance value,
for each current value determined on the basis of the currents measured in the three output phases, a module for storage of the determined corresponding inductance value.

According to a distinctive feature of the system, the module for generation of the reference current is designed to make said current follow a variable profile running initially from a minimal or maximal defined value as far as a respectively maximal or minimal final value.

According to an embodiment, the reference current takes several successive values by following a linear profile.

According to another distinctive feature, the reference current takes several successive values by following a staircase profile having several rungs, each value of the reference current according to a rung of said profile.

### BRIEF DESCRIPTION OF THE FIGURES

Other characteriztics and advantages will become apparent in the detailed description which follows, which has been drawn up with regard to the attached drawings in which:

FIG. 1 illustrates schematically the operating principle of the invention,

FIGS. 2A and 2B show curves of development of the inductance L_{d} and of the flux φ_{d} as a function of the current i_{d},

FIGS. 3A and 3B represent two distinct profiles followed by the reference current for the implementation of the control process of the invention,

FIG. 4 shows timing diagrams illustrating the principle of adaptation in real time of the inductance employed in the control scheme of the motor.

### DETAILED DESCRIPTION OF AT LEAST ONE EMBODIMENT

The invention concerns a control process which is implemented in a processing unit coupled to a power converter. The control process is suitable specifically for the control of a variable-reluctance synchronous electric motor M. The processing unit and the voltage converter are, for example, combined in a variable-speed drive intended to control said electric motor M. The processing unit includes at least one microprocessor and a memory.

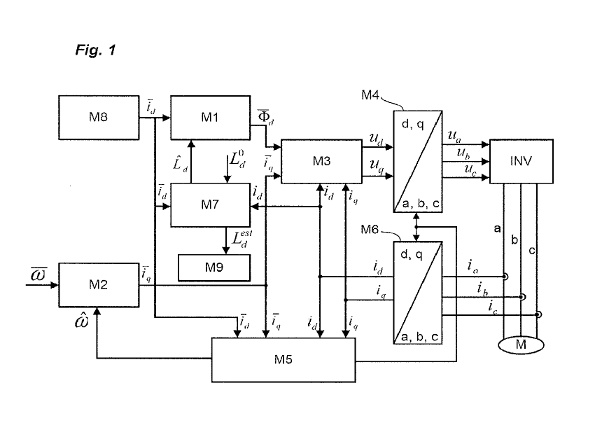

The power converter includes, in known manner, at least one inverter stage INV connected to the electric motor M by several output phases (three phases a, b, c in FIG. 1). The inverter stage comprises several transistors which are controlled to apply variable voltages to the output phases. The control of the transistors is realized by the execution of a control scheme in the processing unit.

In known manner, a scheme for speed control comprises the following elements:
A reference current ī_{d} on axis d of the reference frame d, q linked to the rotor of the motor is applied at the input of a module M1.
On the basis of the reference current and an inductance value \hat{L}_{d}, module M1 determines a reference flux φ̅_̅{̅d̅}̅ on axis d.
On the basis of the reference speed ω̅ and an estimation of the real speed of the motor, a module M2 determines a reference current ī_{q} on axis q.
On the basis of the reference current ī_{q}, the reference flux φ̅_̅{̅d̅}̅, the current i_{d} and the current i_{q} which are representative of the currents measured in each output phase, a module M3 determines the voltages u_{d}, u_{q} to be applied to the motor M.
On the basis of the voltages u_{d}, u_{q}, a module M4 applies a Park transformation in order to determine the voltages uₐ, u_{b}, u_{c} to be applied to each output phase.
A module M5 is designed to estimate the speed \hat{ω} of the motor that is injected into module M2.
A module M6 carries out a Park transformation in order to transform the currents ia, ib, ic measured in each output phase into currents id, iq to be injected at the input of module M3 and of module M5.

The process of the invention consists in obtaining a curve expressing the inductance values of the electric motor as a function of the current i_{d}. The following demonstration explains how the inductance of the motor varies as a function of this current i_{d}.

The general model of a variable-reluctance synchronous electric motor in the reference frame d,q linked to the rotor of the motor is expressed by the following relationships:

$$\{ \begin{matrix}\frac{d}{d t} {φ}_{d} = {u}_{d} - {Ri}_{d} + {ωφ}_{q} \\ \frac{d}{d t} {φ}_{q} = {u}_{q} - {Ri}_{q} - {ωφ}_{d} \\ \frac{{J}_{M}}{{n}_{p}} \frac{d ω}{d t} = \frac{3}{2} {n}_{p} ( {i}_{q} {φ}_{d} - {i}_{d} {φ}_{q} ) - {T}_{L}\end{matrix} \\ in which \text{:} \\ ( \begin{matrix}{φ}_{d} \\ {φ}_{q}\end{matrix} ) corresponds to the electric flux , \\ ( \begin{matrix}{i}_{d} \\ {i}_{q}\end{matrix} ) corresponds to the current of the motor , \\ ( \begin{matrix}{u}_{d} \\ {u}_{q}\end{matrix} ) corresponds to the voltage of the motor , \\ R corresponds to the stator resistance of the motor , \\ {J}_{M} and {n}_{p} are the mechanical parameters of the motor , \\ {T}_{L} is the load torque , \\ ω is the speed of the motor .$$

The magnetic saturation on axis d is represented by the relationship between the flux and the current:

φ_{d}=φ(i_{d}) (1)

in which φ is a function of the current i_{d}.

By similarity to the linear model, and without loss of generality, the function φ is written as a function of the current of axis d in the following form:

φ(i_{d})=L_{d}(i_{d})×i_{d} (2)

in which L_{d} represents the inductance of the motor (by analogy to the linear model) as a function of the current of axis d.

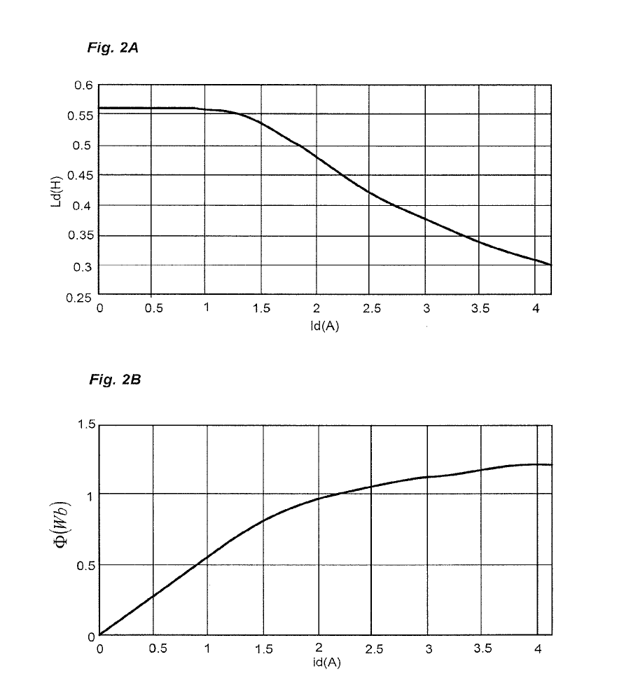

FIGS. 2A and 2B show the development of the inductance L_{d} and of the flux φ_{d} as a function of the current i_{d}.

The control process of the invention aims to reconstitute the curves represented in FIGS. 2A and 2B so as to be able to employ the inductance values determined during the normal operation of the drive.

The control process of the invention includes an identification phase which is implemented in order to identify these inductance values.

FIG. 1 represents the control scheme of the motor, including the blocks that enable this identification phase to be implemented. Once the identification phase has been completed, the control scheme of the motor no longer executes the modules necessary for this identification phase.

Identification phase

The identification phase is implemented in the control scheme outside the normal operation of the motor, and enables the saturation curve described above to be determined. This identification phase is implemented initially—for example, at start-up of the variable-speed drive—before the operating and monitoring phase of the motor.

In the remainder of the description we shall employ the following notations in order to identify the various inductances:
the real inductance of the motor: L_{d}(i_{d})
the inductance used in the control scheme of the motor: \hat{L}_{d}
the inductance estimated by the identification function: L_{d}^{EST}
the inductance used to initialize the identification function: L_{d}⁰

The identification phase is implemented with the aid of a specific module M7 inserted into the control scheme. With reference to FIG. 1, this module M7 takes at its input the reference current l̅_{d}, the measured current i_{d}, the inductance used to initialize the identification function L_{d}⁰, and yields at its output the inductance \hat{L}_{d} used in the control scheme by module M1 and the estimated inductance L_{d}^{EST}.

In order to scan the entire saturation curve described above, it is necessary to vary the reference flux φ̅_{d}. In this way, for each value of (i_{d}, φ̅_{d}) a point on the saturation curve is obtained.

The voltage u_{q} provided by the control scheme is written in conformity with the motor quantities as follows:

u_{q}=Ri_{q}+ω_{d}

By subtracting the resistive term and by using the knowledge of the speed, we obtain the following relationship:

φᵤ=φ(i_{d})=L_{d}(i_{d})i_{d}=φ̅_{d}

where the reference flux is φ̅_{d}=\hat{L}_{d}i_{d} and is obtained at the output of module M1.

Finally the following is obtained:

$${L}_{d} ( {i}_{d} ) = \frac{{\hat{L}}_{d} {\overline{ι}}_{d}}{{i}_{d}} = \frac{ϕ ( {i}_{d} )}{{i}_{d}} \qquad ( 3 )$$

So it will be understood from Equation (3) above that for each value of the measured current i_{d}, a real inductance value L_{d}(i_{d}) is obtained.

A module M8 is employed in order to generate the path of the reference current l̅_{d}, and the reference current l̅_{d} generated in this way is injected into module M1 described above.

In order to cover the entire saturation curve, the reference-current path l̅_{d} has the following characteriztics:

The value of the reference current l̅_{d} is initialized to a value l̅_{d}⁰ that enables the speed to be stabilized.

After the stabilization of the speed, the reference current ī_{d} is reset to a minimal value l̅_{d}^{min}.

In order to cover the saturation curve, the reference current l̅_{d} follows a path going from the minimal value l̅_{d}^{min} to a maximal value l̅_{d}^{min}.

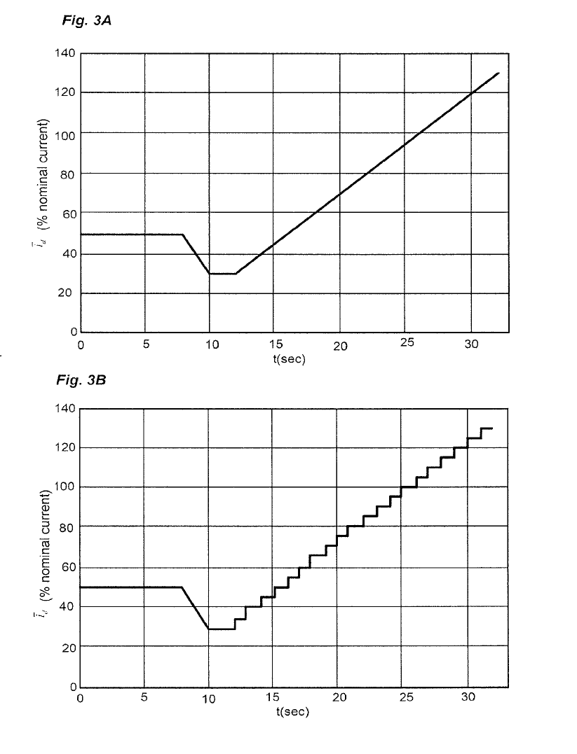

The passage from the minimal value l̅_{d}^{min} to the maximal value l̅_{d}^{min} may be undertaken by several possible methods. However, in order that the monitoring remains stable during the identification phase, it is necessary that the difference between i_{d} and l̅_{d} remains compatible with the stability of the monitored system. In this way, any type of path may be employed that enables the difference Δi_{d}=i_{d}−l̅_{d} to be maintained below a threshold corresponding to a stable operation of the motor. For example, the reference current may follow one of the following two paths:
linear path with slight gradient (FIG. 3A), or
stairway path (FIG. 3B).

According to the invention, the determination of the inductance carried out by module M7 can be realized in two distinct ways:
by direct calculation, or
by adaptation in real time.

By Direct Calculation

The variation of the reference current l̅_{d} enables the saturation curve to be covered. For each value of the reference current l̅_{d} a measured current value i_{d} is obtained. In this way, the estimated inductance L_{d}^{EST} of the motor that corresponds to this current i_{d} is obtained as follows from Equation (3) defined above:

$${L}_{d}^{EST} = \frac{{\hat{L}}_{d} {\overline{ι}}_{d}}{{i}_{d}} {=}^{Δ} {L}_{d} ( {i}_{d} )$$

where \hat{L}_{d} is the inductance used in the monitoring, which is constant in this case and has the value \hat{L}_{d}=L_{d}⁰.

For each level of the reference current the inductance LET obtained by the direct calculation is recorded in the memory, in order to be re-employed later in the course of the operating and monitoring phase of the motor.

By Adaptation in Real Time:

In this case the inductance \hat{L}_{d} is no longer considered to be constant but is considered to be variable as a function of the current difference Δi_{d}=i_{d}−l̅_{d}. In this way, the inductance is obtained in real time in module M7 by using an estimation algorithm which takes Δi_{d} as input and yields \hat{L}_{d} as output. The adaptation of the inductance used in the control scheme of the motor in the course of the identification phase is undertaken in real time as a function of the deviation of the measured current Δi_{d}.

The rule of development of \hat{L}_{d} is the following:

$$\frac{d {\hat{L}}_{d}}{d t} = - {k}_{p} Δ {i}_{d} - {k}_{i} \int Δ {i}_{d} \qquad ( 4 )$$

It will be understood from this development rule that when the current difference Δi_{d}=i_{d}−l̅_{d} becomes zero the inductance \hat{L}_{d} has converged and is constant, and the estimated inductance L_{d}^{EST} is recorded with the value of \hat{L}_{d} obtained at the conclusion of the convergence. Then we have:

L_{d}^{EST}=\hat{L}_{d}

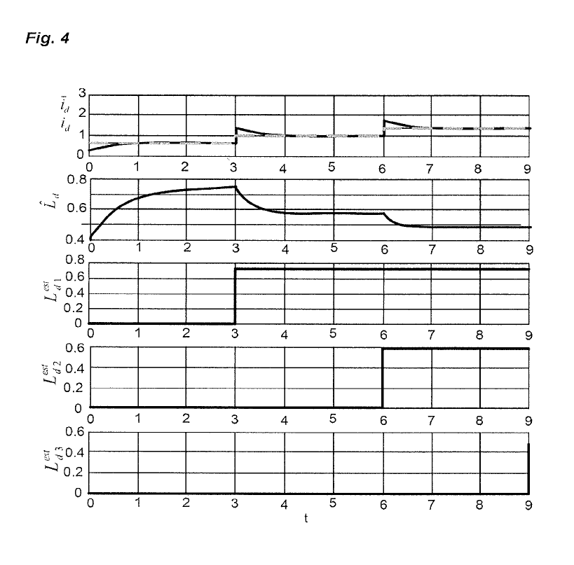

FIG. 4 illustrates the principle of adaptation of the inductance in real time. In this Figure it can be seen that, each time that the measured current i_{d} has converged towards the reference current l̅_{d}, and therefore the difference between these two currents is zero, the inductance \hat{L}_{d} employed in the control scheme of the motor has converged towards a definite value. Each inductance value obtained after convergence is then assigned to the estimated value of the inductance and is thus recorded in the memory by a storage module M9. In FIG. 4, three distinct values L_{d1}^{est}, L_{d2}^{est} and L_{d3}^{est} are stored.

The following demonstration makes it possible to show that the value of the inductance \hat{L}_{d} converges well towards the real inductance L_{d}(i_{d}) when the current difference Δi_{d}=i_{d}−l̅_{d} converges towards zero for a fixed reference current l̅_{d}.

Equation (3) is rearranged as follows:

$${\hat{L}}_{d} = \frac{ϕ ( {i}_{d} )}{{\overline{ι}}_{d}} \qquad ( 5 )$$

We consider l̅_{d} to be constant and we differentiate Equation (5) with respect to time:

$$\frac{d {\hat{L}}_{d}}{d t} = \frac{1}{{\overline{ι}}_{d}} \times \frac{d ϕ}{d {i}_{d}} \times \frac{d {i}_{d}}{d t} \qquad ( 6 )$$

To the first order,

$$\frac{d ϕ}{d {i}_{d}}$$

is approximated as follows:

$${L}_{d}^{t} ( {\overline{ι}}_{d} ) = \frac{d ϕ}{d {i}_{d}} ( {\overline{ι}}_{d} ) > 0$$

By replacing Equation (4) in Equation (6), we obtain, to the first order:

$$- {k}_{p} Δ {i}_{d} - {k}_{i} \int Δ {i}_{d} = \frac{1}{{\overline{ι}}_{d}} \times {L}_{d}^{t} \times \frac{d {i}_{d}}{d t} = \frac{1}{{\overline{ι}}_{d}} \times {L}_{d}^{t} \times \frac{d Δ {i}_{d}}{d t} + \frac{1}{{\overline{ι}}_{d}} \times {L}_{d}^{t} \times \frac{d {\overline{ι}}_{d}}{d t} \qquad$$

Finally, we obtain:

$$\frac{{d}^{2} Δ {i}_{d}}{d {t}^{2}} + ( \frac{{\overline{ι}}_{d} {k}_{p}}{{L}_{d}^{t}} ) \frac{d Δ {i}_{d}}{d t} + ( \frac{{\overline{ι}}_{d} {k}_{i}}{{L}_{d}^{t}} ) Δ {i}_{d} = - \frac{{d}^{2} {\overline{ι}}_{d}}{d {t}^{2}}$$

By choosing kₚ>0, kᵢ>0 and l̅_{d}>0, and knowing that L_{d}^{t}>0, the above system is stable. Thus Δi_{d} converges towards 0, and \hat{L}_{d} towards L_{d}. For example, the gains kₚ and kᵢ are chosen as follows:

$${k}_{p} = \frac{{L}_{d}^{0}}{{\overline{ι}}_{d}} \times 2 {ξ}_{l} {ω}_{l} , {k}_{i} = \frac{{L}_{d}^{0}}{{\overline{ι}}_{d}} \times {ω}_{l}^{2}$$

Where ξₗ is the damping coefficient and ωₗ=2πfₗ with fₗ the pass-band of the estimator of the inductance; L_{d}⁰ is the inductance that is used to initialize the identification function.

The proposed procedure for estimation of inductance thus makes it possible to have a saturation curve of the inductance L_{d} as a function of the current i_{d}, which covers the entire working range of the motor (FIG. 2).

This curve is implemented in the drive as a function of the current id, and said curve is taken into account in real time during the monitoring of the motor.

In addition, the solution of the invention enables the performance data of the motor to be improved, notably:
the maximum torque can be increased,
the consumption of electrical energy can be reduced,
the stability of the monitoring of the motor can be improved.

1. A process for controlling a variable-reluctance synchronous electric motor, implemented in a processing unit, said processing unit being coupled to a power converter connected by output phases to said electric motor and designed to execute a control scheme with a view to applying variable voltages to said electric motor, wherein said process includes a phase of identifying a flux inductance value of said electric motor and in that this identification phase comprises:
generation of generating a reference current (ī_{d}) at the beginning of said control scheme, said reference current (ī_{d}) taking successively several values according to a predetermined profile,
determining, for each reference-current value (ī_{d}), a current value (i_{d}) corresponding to currents measured in the output phases of the motor,
for each reference-current value (ī_{d}), by an identification module, an inductance value (L_{d}^{EST}) as a function of a reference-current value applied at the input, the corresponding current value determined on the basis of the currents measured in the output phases, and a predetermined or variable inductance value (\hat{L}_{d}), and
storing, for each current value (i_{d}) determined on the basis of the currents measured in the three output phases, the corresponding inductance value (L_{d}^{EST}) determined.

2. The process according to claim 1, wherein the reference current (ī_{d}) follows a variable profile running from a defined initial minimal or maximal value (ī_{d}^{min}) as far as a respectively maximal or minimal final value (ī_{d}^{max}).

3. The process according to claim 2, wherein the reference current (ī_{d}) takes several successive values by following a linear profile.

4. The process according to claim 2, wherein the reference current takes several successive values by following a staircase profile having several rungs, each value of the reference current according to a rung of said profile.

5. The process according to claim 1, wherein said process includes an operating phase which follows the identification phase and in that said operating phase consists in utilising each inductance value (L_{d}^{EST}) stored in the course of the identification phase, in order to determine a reference flux to be applied to the motor.

6. A system for controlling a variable-reluctance synchronous electric motor, including a processing unit, said processing unit being coupled to a power converter connected by output phases to said electric motor and designed to apply variable voltages to said electric motor by executing a control scheme, wherein the control scheme comprises:
a module for generation of a path of a reference current (ī_{d}),
a module for determination, for each value of the reference current, of a current value (i_{d}) determined on the basis of currents measured in the output phases,
a module for identification of each inductance value (L_{d}^{EST}) of the electric motor on the basis of a reference-current value (ī_{d}), the corresponding current value (ī_{d}) determined on the basis of the currents measured in the output phases, and a predetermined or variable inductance value (\hat{L}_{d}), and
for each current value (i_{d}) determined on the basis of the currents measured in the three output phases, a module for storage of the determined corresponding inductance value (L_{d}^{EST}).

7. The system according to claim 6, wherein the module for generation of the reference current (ī_{d}) is designed to make said current follow a variable profile running initially from a minimal or maximal defined value (ī_{d}^{min}) as far as a respectively maximal or minimal final value (ī_{d}^{max}).

8. The system according to claim 7, wherein the reference current (ī_{d}) takes several successive values by following a linear profile.

9. The system according to claim 7, wherein the reference current (ī_{d}) takes several successive values by following a staircase profile having several rungs, each value of the reference current according to a rung of said profile.
